(19) United States
(12) Patent Application Publication
(10) Pub. No.: US 2005/0001066 A1
(43) Pub. Date: Jan. 6, 2005

(54) Spiral nozzle

(75) Inventors: Manabu Miyamoto, Hyogo-ken (JP); Masayuki Yamamoto, Hyogo-ken (JP); Toshiyuki Naito, Tokyo (JP)

Correspondence Address: OSTROLENK FABER GERB & SOFFEN, 1180 AVENUE OF THE AMERICAS, NEW YORK, NY, 100368403, US

(73) Assignees: Ishikawajima-Harima Heavy Industries Co., Ltd.; Kyoritsu Gokin Co., Ltd.

(21) Appl. No.: 10/866,199

(22) Filed: Jun. 10, 2004

(30) Foreign Application Priority Data
Jun. 12, 2003 (JP) 2003-168247

(51) Int. Cl. C01B 7/00; B01J 8/00; B05B 1/26

(52) U.S. Cl. 239/461; 239/463; 239/490

(57) ABSTRACT

A spiral nozzle comprises a spray guide which sprays droplets of a liquid. The spray guide is formed in a helix converging towards its own central axis L, and has a liquid impingement face inclined at predetermined angles with respect to the central axis L so that a distribution pattern of the liquid in a plane perpendicular to the central axis L is in the form of a spiral shape.

### BACKGROUND OF THE INVENTION

1. Field of the Invention

The present invention relates to a spiral nozzle.

Priority is claimed on Japanese Patent Application No2003-168247, filed Jun. 12, 2003, the content of which is incorporated herein by reference.

2. Description of Related Art

The flue gas, which is discharged, for example, from the boiler of a thermal power plant using coal as fuel, contains a sulfur component. Increasing environmental awareness in recent years, removal of the sulfur component contained in the flue gas is required, and desulfurization equipment is therefore installed in thermal power plants and the like. As is well known, three processes: a wet process, a dry process, and a semi-dry process, are generally used in this desulfurization equipment. Of these three processes, desulfurization equipment using the wet process sprays droplets of an alkaline solution containing calcium carbonate into the flue gas, to thereby neutralize the sulfur component of the flue gas with the alkaline component, and at the same time absorb the sulfur component in the droplets of alkaline solution, and thus remove the sulfur component from the flue gas.

A hollow cone, full cone, or spiral nozzle is normally used in the desulfurization equipment to spray droplets of the alkaline solution. Of these, the spiral nozzle as shown in FIGS. 1 and 2, comprises a spray guide 100 which is formed in a helix converging towards its own central axis L, and a support part 200 which is formed integral with one end of the non-converging side of the spray guide 100, and formed with a conduit port 210 for passing an alkaline solution. FIG. 2 is a view of the spiral nozzle in FIG. 1 as seen from the left horizontal direction.

The spray guide 100 is formed in three coil parts 110, 120, and 130 connected in the central axis L direction, in other words, in a three-tiered coil structure. The bottom faces of the coil parts 110, 120, and 130 (the faces towards the non-converging side) are formed as liquid impingement faces 111, 121, and 131, which are set so that the angle of each with respect to the central axis L differs. The entirety of each the liquid impingement faces 111, 121, and 131 is set at a fixed angle with respect to the central axis L.

The support part 200 is formed integral with one end of the coil part 130, in other words, with one end on the non-converging side of the spray guide 100, and a flange 300 is formed integral with its own end (bottom end in FIG. 1 and FIG. 2).

The spiral nozzle configured in this manner is fixed to a supply device (not shown in drawings) which supplies an alkaline solution to the spiral nozzle at a predetermined pressure, by a support plate 400 formed separate from the spiral nozzle and having through holes 410 penetrated by bolts or screws. More specifically, a support plate flange 420 is formed on the support plate 400, and as shown in the drawing, the support plate flange 420 and the flange 300 are joined with adhesive, and the support plate 400 is fixed to the supply device with the bolts 500, thus fixing the spiral nozzle to the supply device. Moreover, the spray guide 100, the support part 200, and the flange 300 are formed of a ceramic material to prevent corrosion by the alkaline solution. Furthermore, plastic is used for the support plate 400, and metal is used for the bolts 500.

When the alkaline solution is supplied to the spiral nozzle from the supply device at a predetermined pressure, the alkaline solution discharged from the supply device is supplied to the spray guide 100 via the conduit port 210. The alkaline solution then impinges on the liquid impingement faces 111, 121, and 131, thus forming fine droplets which are sprayed to the outside.

FIG. 3 shows schematically the distribution pattern (hereafter referred to as the ‘spray pattern’) in a plane perpendicular to the central axis L, of the alkaline solution sprayed from the spiral nozzle. As shown in this drawing, the alkaline solution is distributed in three concentric circles. This is due to the spray guide 100 having a three-tiered coil structure as explained above, wherein the three coil parts 110, 120, and 130 having the liquid impingement faces 111, 121, and 131 are connected inclined each at different angles.

‘Spray guide’ and ‘spray pattern’ are terms normally used in this technical field, and the term ‘spray’ as used here refers to an aggregation of droplets having a particle size of, for example, a few millimeters.

For details of the aforementioned technology, refer to Patent document 1 (Japanese Unexamined Patent Application, First Publication No. Sho 63-111954), Patent document 2 (Japanese Unexamined Patent Application, First Publication No. Hei 9-57155), and Patent document 3 (U.S. Pat. No. 2,804,341).

However, as explained above, since the coil parts 110, 120, and 130 have the liquid impingement faces 111, 121, and 131, each inclined at different angles, then at a connection site A of the coil part 110 and the coil part 120 and a connection site B of the coil part 120 and the coil part 130, there is naturally formed an inclined face ‘a’ connecting the liquid impingement faces 111 and 121, and an inclined face ‘b’ connecting the liquid impingement faces 121 and 131. Formation of these inclined faces ‘a’ and ‘b’ results in an increase in the overall length of the spiral nozzle, increasing the amount of material required for formation of the spiral nozzle, and inviting an increase in manufacturing costs. As explained above, since the spiral nozzle is formed of a ceramic material, even a small increase in the amount of material results in a particular increase in manufacturing cost. Moreover, an increase in the overall length of the nozzle results in a reduction in the number able to be inserted in the furnace for firing, an increase in defects due to collapse, and a consequent further increase in manufacturing cost.

Furthermore, as shown in FIG. 3, the spray pattern of this type of spiral nozzle is distributed in three concentric circles. Therefore spray patterns a1 and b1 occur naturally to connect the individual concentric spray patterns in order to ensure that the individual concentric spray patterns are contiguous. The spray patterns a1 and b1 occur due to the inclined faces ‘a’ and ‘b’, and the overall spray pattern becomes nonuniform due to the occurrence of the spray patterns a1 and b1. In other words, the flow rate of the alkaline solution sprayed from the spiral nozzle is locally increased, and the sulfur component can no longer be uniformly removed from the flue gas.

Moreover, since between about 1,000 and 2,000 spiral nozzles of this type are provided in the desulfurization equipment, there is also a problem in that the cost of the desulfurization on equipment becomes extremely high.

Additionally, as shown in FIGS. 1 and 2, the flange 300 and the support plate 400 are currently joined with adhesive. Therefore in some environments the adhesive deteriorates, with the possibility of a reduction in life of the spiral nozzle. If the life of the spiral nozzle is reduced, the spiral nozzle must be replaced each time, and the number of replacements is thus increased, so that the maintenance cost of the desulfurization equipment is increased.

The present invention takes into consideration the aforementioned problems, with an object of addressing the following points: (1) uniform treatment by uniform spraying of the solution; (2) a reduction in the manufacturing cost of the spiral nozzle by reducing the amount of material forming the spiral nozzle, and the length of the spiral nozzle; (3) a reduction in the manufacturing cost of the equipment incorporating the spiral nozzle by reducing the number of installed spiral nozzles; and (4) a reduction in the maintenance cost of the equipment incorporating the spiral nozzle by extending the life of the spiral nozzle.

### SUMMARY OF THE INVENTION

In order to achieve the aforementioned objects, the present invention adopts as a first means a configuration where, in a spiral nozzle which sprays droplets of a liquid from a spray guide formed in a helix converging towards its own central axis, the spray guide has a liquid impingement face inclined at a predetermined angle with respect to the central axis so that a distribution pattern of the liquid in a plane perpendicular to the central axis is in the form of a spiral shape.

As a second means there is adopted a configuration where, in the first means, the distribution pattern of the liquid has a spiral shape winding at approximately equal spaced pitch.

As a third means there is adopted a configuration where, in either one of the first and second means, a surface on the central axis side of the spray guide is specified by a surface of a rotating body obtained by rotating an arc having a predetermined radius with respect to the central axis.

As a fourth means there is adopted a configuration where, in the third means the predetermined radius is less than 2,000 mm.

As a fifth means there is adopted a configuration where, in a spiral nozzle having a spray guide formed in a helix converging towards its own central axis, and a support part formed integral with an other end of the spray guide and in which is formed a conduit port for passing a liquid, and which sprays droplets of a liquid from the spray guide, a corner being a site of connection of the spray guide and the support part and a site of the start of the spray guide, is formed along an arc having a predetermined radius.

As a sixth means there is adopted a configuration where, in the fifth means the predetermined radius is greater than 3 mm.

As a seventh means there is adopted a configuration where either one of the fifth and sixth means has a flange formed integral with the support part and formed with through holes that are penetrated by bolts or screws.

As an eighth means there is adopted a configuration where, in any one of the first through seventh means, all components are formed of the same ceramic material.

### BRIEF DESCRIPTION OF THE DRAWINGS

FIG. 1 is a front view of a spiral nozzle according to conventional technology.

FIG. 2 is a side view from the left of the spiral nozzle in FIG. 1.

FIG. 3 is a drawing showing a spray pattern according to conventional technology.

FIG. 4 is a front view of a spiral nozzle according to one embodiment of the present invention.

FIG. 5 is a side view from the left of the spiral nozzle in FIG. 4.

FIG. 6 is a drawing showing a spray pattern according to the one embodiment of the present invention.

FIG. 7 is a drawing showing a spray pattern according to another embodiment of the present invention.

### DETAILED DESCRIPTION OF THE INVENTION

The following explains one embodiment of a spiral nozzle of the present invention, with reference to the drawings.

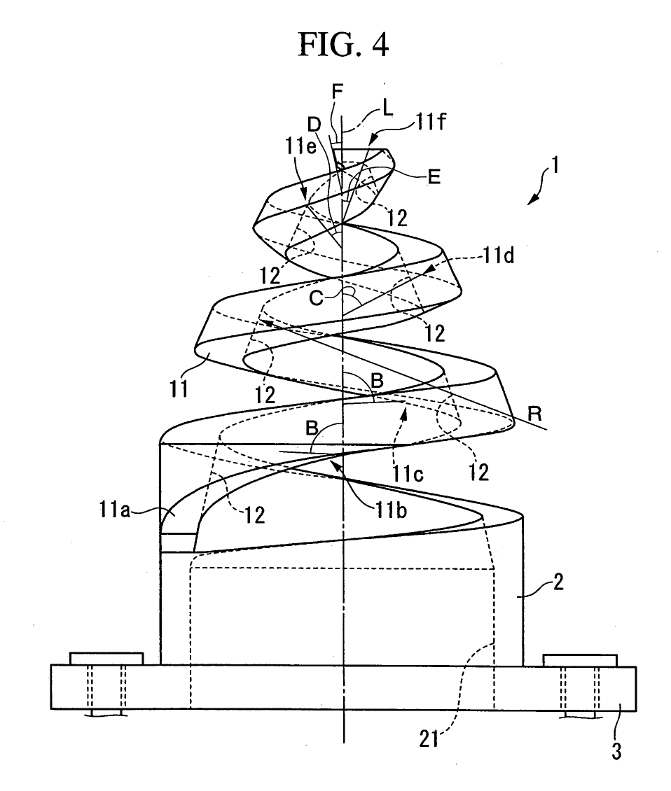

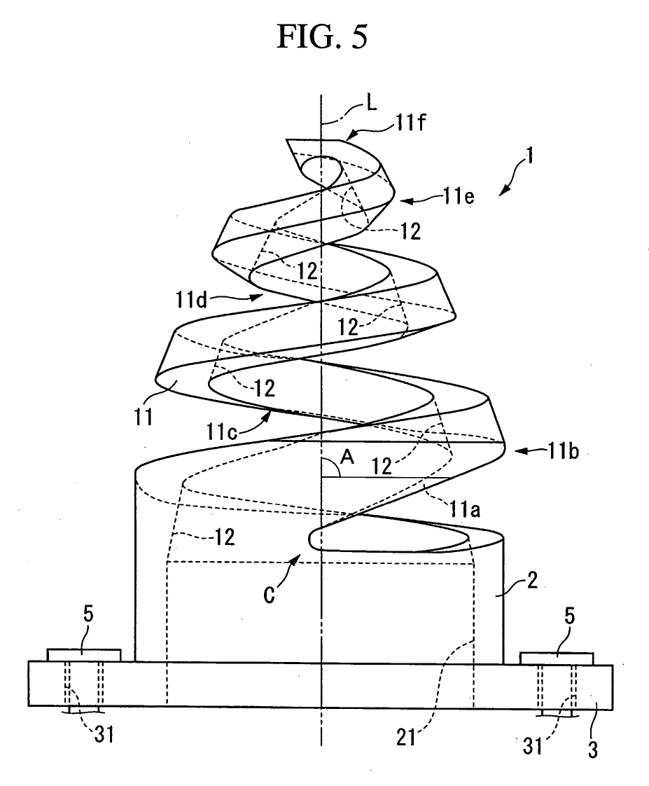

FIG. 4 is a front view of the spiral nozzle according to this embodiment, and FIG. 5 is a side view from the left of the spiral nozzle in FIG. 4. As shown in these drawings, the spiral nozzle according to this embodiment is provided with a spray guide 1 formed in a helix converging towards its own central axis L, a support part 2 formed integral with one end (the base) on the non-converging side of the spray guide 1 and with a conduit port 21 for passing an alkaline solution, and a flange 3 formed integral with one end of the support part 2 (bottom end in FIG. 4 and FIG. 5), all of these components being formed integral. All components of this spiral nozzle (the spray guide 1, the support part 2, and the flange 3) are formed integral. Moreover they are formed of the same fired ceramic material (for example, Si—SiC) in order to ensure durability when used with an alkaline solution.

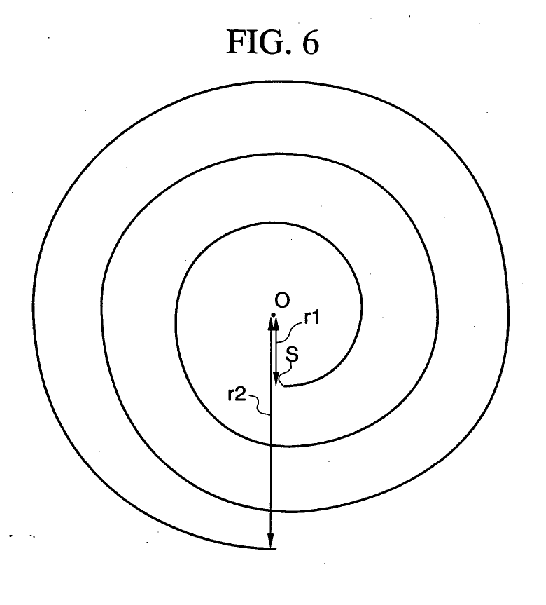

The spray guide 1 comprises a single three-coil winding with its own bottom face (the face towards the base side) being formed as a liquid impingement face 11 and having an angle with respect to the central axis L specified for each part. Here, the angle of the liquid impingement face 11 with respect to the central axis L is the angle formed between a line of intersection of a plane including the central axis L and the liquid impingement face 11, and the tip central axis L side (the converging side 1 (tip side) of the spray guide 1). Each part of the liquid impingement face 11 of the spiral nozzle according to the present invention is inclined at a predetermined angle to ensure that a spray pattern having a spiral shape with approximately equal pitch as shown in FIG. 6 is obtained. More specifically, as shown in the drawing, a liquid impingement face 11a at a start portion of the spray guide 1 is formed so that its angle A with the central axis L is 90°, and an angle B between a mid-part 11b of the first coil and a mid-part 11c of the first coil is 89°. Furthermore, to ensure that the angle for from the mid-part 11c of the first coil to the end of the third coil varies continuously, the liquid impingement face 11 is inclined with respect to the central axis L so that; an angle C at a mid-part 11d of the second coil is60°, an angle D at a mid-part lie of the third coil is 45°, an angle E at a mid-part 11f of the third coil is 26°, and an angle F at the end of the third coil (tip of the spray guide 1) is 20°, and thus a spray pattern having a spiral shape winding at approximately equal pitch as shown in FIG. 6 is obtained. The spiral shape winding has an inside end S and an outside end E, and the radius of the spiral shape winding from the center O gradually increases from the inside end S (radius r1) to the outside end E (radius r2).

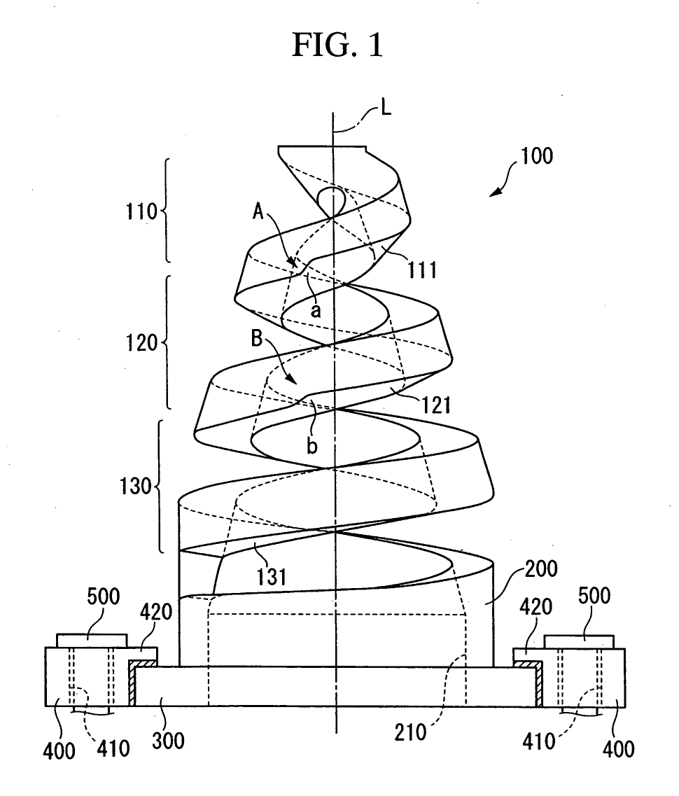

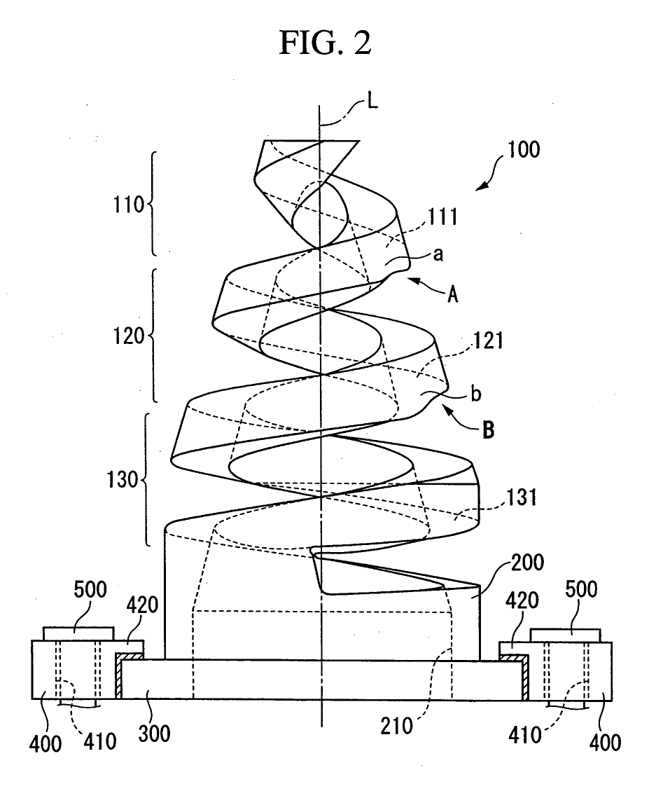

By forming the spray guide 1 while specifying the angle with respect to the central axis L of the liquid impingement face 11 to ensure that the spray pattern has a spiral shape, the angle of the liquid impingement face 11 is gradually and continuously changed with respect to the central axis L. The inclined faces ‘a’ and ‘b’ of the conventional spiral nozzle as shown in FIGS. 1 and 2 are therefore not formed, and it is consequently possible to form the spiral nozzle of the present invention with a comparatively small amount of material.

Moreover, the face 12 on the central axis L side of the spray guide 1 is specified by the surface of a body of revolution obtained by rotating an arc of radius 500 mm with respect to the central axis L. Consequently the face 12 on the central axis L side of the spray guide 1 forms a curved surface expanded outwards. Therefore the space enclosed within the spray guide 1 increases, enabling supply of a larger volume of alkaline solution to the spray guide 1, and the spraying of a larger volume of alkaline solution from a single spiral nozzle than is conventionally the case.

Consequently a reduction in the number of spiral nozzles installed in the desulfurization equipment is possible, enabling a reduction in the manufacturing cost of the desulfurization equipment.

Preferably the face 12 on the central axis L side of the spray guide 1 is specified by the surface of a body of revolution obtained by rotating an arc having a radius within a range of greater than the diameter of the conduit port 21, and less than 2,000 mm.

This is because, if the face 12 on the central axis L side of the spray guide 1 is specified by a surface of a body of revolution obtained by rotating an arc having a radius greater than 2,000 mm, a curved surface sufficient to enclose a large enough volume within the spray guide 1 is not formed. Furthermore, if the diameter is less than that of the conduit port 21, sufficient length in the central axis L direction of the spray guide 1 cannot be maintained, and it become difficult to form the spray guide 1.

A corner C, being the site of connection of the spray guide 1 and the support part 2 and the site of the start of the spray guide 1, is formed along an arc of radius 4 mm. This corner C becomes a stress concentration region when the alkaline solution is supplied to the spray guide 1 at a predetermined pressure. By forming this corner C along an arc of radius 4 mm, the stress can be dispersed, enabling an increase in the durability of the spiral nozzle.

Furthermore, as explained above, when the face 12 on the central axis L side of the spray guide 1 is formed along an arc of a predetermined radius, the wall of the spray guide 1 is thin. However even in this case, forming the corner C along an arc of a predetermined radius enables sufficient durability to be obtained.

The corner C may be formed along an arc of a radius greater than 3 mm. If the corner C is formed along an arc of a radius of less than 3 mm, the stress loading on the corner C increases, and sufficient durability cannot be expected.

Moreover, through holes 31 are formed in the flange 3 for penetration of bolts (or screws) 5 to fasten together the spiral nozzle and a supply device (not shown in the drawings) which supplies the alkaline solution to the spiral nozzle at a predetermined pressure.

Direct formation of through holes 31 in the flange 3 in this manner eliminates the need for the support plate 400 as shown in FIGS. 1 and 2, and thus the spiral nozzle can be readily formed. Furthermore, since joining of the flange 420 formed in the support plate 400 and the flange 300 with adhesive is no longer necessary, reduction in lifespan of the spiral nozzle due to deterioration of the adhesive is eliminated, and the life of the spiral nozzle may be extended, thus reducing the maintenance costs of the desulfurization equipment.

When the alkaline solution is supplied to the spiral nozzle configured in this manner from the supply device at a predetermined pressure, the alkaline solution is formed into liquid droplets by impinging on the liquid impingement face 11 of the spray guide 1, and a spray pattern having a spiral shape winding at approximately equal pitch is obtained.

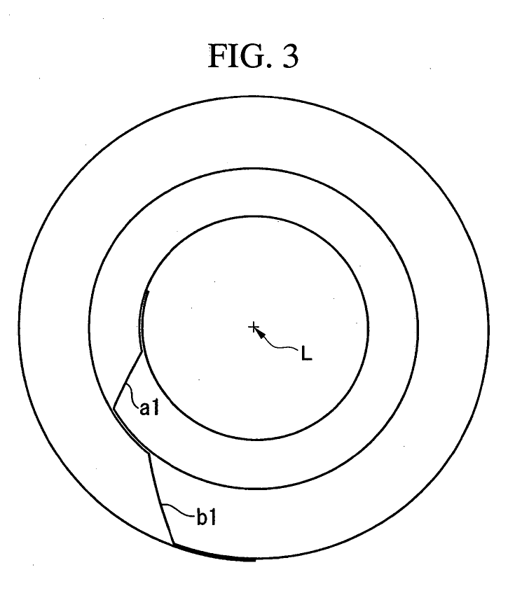

Consequently, in comparison with the conventional spiral nozzle which distributes the spray pattern in three concentric circles as shown in FIG. 3, the alkaline solution can be distributed more uniformly, thus enabling an improvement in the desulfurization effect.

### EXAMPLE

Liquid was supplied at a pressure of 0.03 MPa to a spiral nozzle according to the aforementioned embodiment, having an overall length of 200 mm, a length in the direction of the central axis L of the spray guide 1 of 145 mm, a diameter of the support part of 120 mm, and a diameter of the conduit port 21 of 100 mm, with the face 12 on the central axis side of the spray guide 1 specified by the surface of a body of revolution obtained by rotation of an arc of a radius of 500 mm with respect to the central axis L, a corner C formed along an arc of a radius of 4 mm, and formed of Si—SiC having a modulus of elasticity of the overall body of 360 GPa, and a Poisson's ratio of 0.19. In this case, the flow rate of the liquid sprayed from the spiral nozzle was 2,800 L/min, and the stress loading on the corner C was 30 MPa.

### COMPARATIVE EXAMPLE

In contrast, liquid was supplied at a pressure of 0.03 MPa to a spiral nozzle according to the conventional technology, having an overall length of 250 mm, a length in the direction of the central axis L of the spray guide 1 of 180 mm, a diameter of the support part of 120 mm, and a diameter of the conduit port 21 of 100 mm, with the face 12 on the central axis side of the spray guide 1 specified by the surface of a body of revolution obtained by rotation of a straight line with respect to the central axis L, a corner C formed along an arc of a radius of 2 mm, and formed of Si—SiC having a modulus of elasticity of the overall body of 360 GPa, and a Poisson's ratio of 0.19. In this case, the flow rate of the liquid sprayed from the spiral nozzle was 2,000 L/min, and the stress loading on the corner C was 38 MPa.

In this way it was demonstrated that the flow rate of the sprayed liquid can be increased in comparison to the spiral nozzle according to conventional technology, and the stress loading on the corner C can be reduced.

A preferred embodiment according to the present invention has been described above with reference to the appended drawings. However it is naturally not restricted to the example of the present invention. The various shapes and assembly and the like of the components illustrated in the aforementioned example relate to a single example, and may be variously changed based on design requirements, provided they remain within the scope of the gist of the present invention.

For example, in the aforementioned embodiment the spiral nozzle is described as being installed in desulfurization equipment. However it is not restricted to this application, and may also be installed in dust settling equipment, and in gas cooling equipment. In such cases, the spiral nozzle need not be formed of a ceramic material.

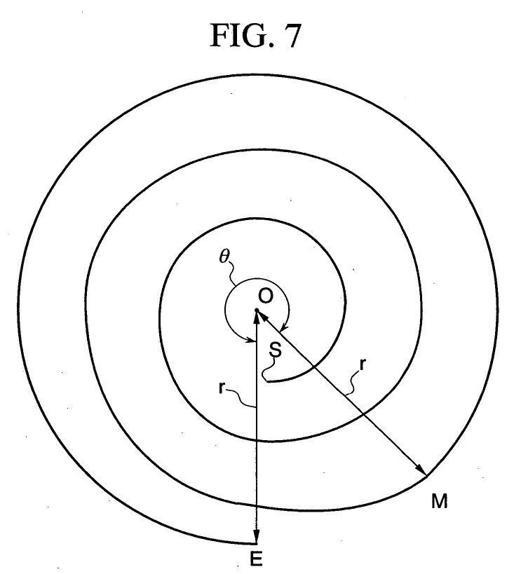

FIG. 7 is a drawing showing a spray pattern according to another embodiment of the present invention. In the spray pattern shown in FIG. 6, the radius of the spiral shape winding from the center O gradually increases from the inside end S to the outside end E. In contrast, the spray pattern shown in FIG. 7 has an inner spiral winding S-M and an outermost arc M-E. The radius of the inner spiral winding S-M from the center O gradually increases from the inside end S to the point M (radius r). In contrast, the outermost arc M-E has a substantially constant radius r. The central angle θ of the outermost arc M-E is not limited, but it is preferably between 180° and 360°. More preferably, the center angle θ is between 225° and 315°.

In this embodiment, because the outer periphery of the spray area has a shape near a complete circle, it is easy to arrange a plurality of the spray nozzles so as to obtain a uniform spray density.

As explained above, according to the present invention, the spiral nozzle sprays liquid in droplets from the spray guide formed in a helix converging towards its own central axis L, and the spray guide has a liquid impingement face inclined at a predetermined angle so that the liquid distribution pattern in a plane perpendicular to the central axis L forms a spiral shape, and thus the liquid is sprayed uniformly, enabling uniform treatment.

1. A spiral nozzle for spraying droplets of a liquid, comprising a spray guide formed in a helix converging towards its own central axis, wherein said spray guide has a liquid impingement face inclined at a predetermined angle with respect to said central axis so that a distribution pattern of said liquid in a plane perpendicular to the central axis is in the form of a spiral shape.

2. A spiral nozzle according to claim 1, wherein said distribution pattern of the liquid has a spiral shape winding at approximately equal spaced pitch.

3. A spiral nozzle according to claim 1, wherein a surface on the central axis side of said spray guide is specified by a surface of a rotating body obtained by rotating an arc having a predetermined radius with respect to said central axis.

4. A spiral nozzle according to claim 3, wherein said predetermined radius is less than 2,000 mm.

5. A spiral nozzle having a spray guide formed in a helix converging at one end towards its own central axis, and a support part formed integral with an other end of said spray guide and in which is formed a conduit port for passing a liquid, and which sprays droplets of a liquid from said spray guide, wherein a corner being a site of connection of said spray guide and said support part and a site of the start of said spray guide, is formed along an arc having a predetermined radius.

6. A spiral nozzle according to claim 5, wherein said predetermined radius is greater than 3 mm.

7. A spiral nozzle according to claim 5, having a flange formed integral with said support part and formed with through holes that are penetrated by bolts or screws.

8. A spiral nozzle according to claim 1, wherein all components are formed of the same ceramic material.

9. A spiral nozzle according to claim 1, wherein the distribution pattern of said liquid in a plane perpendicular to the central axis is in the form of a spiral, the spiral has an inner spiral winding and an outermost arc, the radius of the inner spiral winding from the central axis gradually increases from an inside end toward the outermost arc, the outermost arc has a substantially constant radius, and an central angle of the outermost arc is more than 180°.

10. A spiral nozzle according to claim 5, wherein all components are formed of the same ceramic material.

11. A spiral nozzle according to claim 5, wherein the distribution pattern of said liquid in a plane perpendicular to the central axis is in the form of a spiral, the spiral has an inner spiral winding and an outermost arc, the radius of the inner spiral winding from the central axis gradually increases from an inside end toward the outermost arc, the outermost arc has a substantially constant radius, and an central angle of the outermost arc is more than 180°. (00660151.1}
